(19) United States
(12) Patent Application Publication
(10) Pub. No.: US 2010/0066134 A1
(43) Pub. Date: Mar. 18, 2010

(54) Bicycle Saddle

(75) Inventor: Thomas GÖRING, Karlsruhe (DE)

Correspondence Address: WOMBLE CARLYLE SANDRIDGE & RICE, PLLC, ATTN: PATENT DOCKETING, P.O. BOX 7037, ATLANTA, GA, 30357-0037, US

(73) Assignee: Wolfgang Goring, Karlsruhe (DE)

(21) Appl. No.: 12/559,648

(22) Filed: Sep. 15, 2009

(30) Foreign Application Priority Data
Sep. 17, 2008 (DE) 10 2008 048 550.0

(51) Int. Cl. B62J 1/08

(52) U.S. Cl. 297/195.1

(57) ABSTRACT

A bicycle saddle (1) has a saddle bar (3) to be introduced into a cycle frame and a seating area (2) having a seat surface, in which the saddle bar (3) at its end region closest to the seating area comprises a polygonal outer profile (6), the seating area (2) being at least partially formed by a base body (4), in which a passage opening (5) is provided, the passage opening (5) having a polygonal inner profile (7) at least in a sub-area, and the polygonal inner profile (7) of the passage opening (5) corresponds to the polygonal outer profile (6) of the saddle bar (3).

### RELATED APPLICATION

The present invention claims priority to DE 10 2008 048 550.0, which was filed Sep. 17, 2008. The entire enclosure of the DE 10 2008 048 550.0 is incorporated herein by reference.

### BACKGROUND OF THE INVENTION

The invention relates to a bicycle saddle.

From the DE-OS 1 680 547 a bicycle saddle is known, which comprises a triangular seat part in an elastically deformable material and on its back side two vertical pressure springs, which support the seat part, which on the other hand are anchored at a mounting, with which the saddle is fixed. The anchorage is done by means of a blocking device, into which the end of a saddle bar is introduced. Such saddle bars are formed by pipes with circular cross-section. The opposite end is introduced into the cycle frame and clamped herein with the help of a similar blocking device.

A comparable embodiment of a bicycle saddle is known also from the DE 30 19 649 A1. Here too the saddle bar is introduced from the bottom into a blocking device and clamped.

The invention therefore is based on the task to improve such a bicycle saddle. Especially the saddle is to be dismountable as simply as possible, in order to replace expendable parts or damaged parts, as well as in order to recycle the saddle.

### BRIEF SUMMARY OF SOME ASPECTS OF THE INVENTION

In accordance with an embodiment of the present invention, a bicycle saddle with a saddle bar for introduction into a cycle frame and a seating area comprising a seat surface is formed in such a way that the saddle bar at its end region toward the seating area comprises a polygonal external profile, the seating area at least partially is formed by a base body, in which a passage opening is provided, the passage opening at least in one sub-area comprising a polygonal internal profile, and the polygonal internal profile of the passage opening corresponds to the polygonal external profile of the saddle bar, especially with a suitable size. The provision of the interworking polygonal profiles makes possible an anti-rotation connection between the saddle bar and seating area. The connection of the saddle bar and seating area can be formed particularly simply in that the saddle bar is introduced from the seat surface into the passage opening in the base body. The conventional complicated fastenings of clamping devices on the seating area may be dispensed with, so that the bicycle saddle can be produced very economically. Moreover the plug-in connection makes possible a simple separation of the parts, which usually consist of different materials, so that besides a replacement of expendable parts or damaged parts also a simple separation of the materials for recycling is possible.

Particularly preferably on the saddle bar a clamping ring is arranged, which rests against the base body at the side opposite the seat surface. The clamping ring can be pushed simply from below onto the saddle bar.

The base body above and/or below the polygonal internal profile preferably presents a contact surface which is oriented toward the seat surface, against which a corresponding contact surface of the saddle bar rests. Particularly preferably the contact surface of the saddle bar is formed by an outwardly protruding flange arranged at an end of the saddle bar, which on the seat surface side of the base body is incorporated in a deepening on the corresponding contact surface of the base body and rests against the base body.

A possibly smooth seat surface is preferably provided by a plug, especially a rubber plug, that is plugged or pinned into a hole that is located at an end of the passage opening, is oriented toward the seat surface, and is at least partially defined by the introduced saddle bar.

The polygonal profile is preferably a square, hexagon or octagon profile, however any other profile is possible which prevents a twist, like for example a cylinder profile with a plane surface. Also profiles are conceivable, in which a spring is laid into a groove provided in both cylinder profiles, so that both parts are anti-rotationally connected to each other.

The saddle bar preferably presents three sections with different external diameters, the first section being formed by a hollow or cylinder profile, the second section by said polygonal external profile with areas protruding over the external diameter of the hollow or cylinder profile at least in the edge areas, and the third section is formed by a flange at least protruding over the edge area of the polygonal external profile.

Moreover the saddle bar can be formed multiple with an adapter part, which makes possible an inclination adjustability of the bicycle saddle as to the saddle bar. For this purpose preferably the adapter part in at least one section is provided with a polygonal external profile and with a passage opening with a polygonal internal profile provided in at least one section. The first part of the saddle bar, which constitutes the saddle bar in association with the adapter part, and the base body present corresponding polygonal profiles, so that the adapter part is arranged between the base body and the first part of the saddle bar and is held anti-rotationally.

Particularly preferably from the seat surface side a flange of the first part of the saddle bar rests against the adapter part, and a flange formed on the adapter part rests for its part against the base body from the seat surface side. Alternatively also a flange of the first part can rest against the adapter part from the seat surface side, and the adapter part rests against the base body on the opposite side. In either instance a simple fixing of the bipartite saddle bar and of the base body can be realized, for example with the help of a clamping ring pushed on at the bottom.

For easier assembly—especially in case of profiles with more than two mounting positions, like for example in the event of hexagon profiles, in the case of which sensible orientations are not possible—arrows or other markings can mark the correct orientation of the saddle bar in the base body or in case of a multipart saddle bar also the orientation of the first part as to the adapter part.

The profiles preferably present a cross-section with a point symmetry, so that the adapter part in one position for example makes possible a saddle inclination forward and in the position rotated by 180° a corresponding saddle inclination backwards.

Particularly preferably the polygonal external profile and the polygonal internal profile of the adapter part are not arranged coaxially to each other. The profiles can be arranged either at an angle towards each other or parallelly displaced to each other.

If the profiles are arranged at an angle one towards the other, this is preferably greater than 0° and maximum 15°, in particular at most 10°, exceptionally preferably maximum 5°. By the use of different adapter parts with different angles of the profiles, any inclination adjustment of the base body is allowed.

In case of a parallel but displaced arrangement of the profiles, the saddle position can be varied simply forwardly or backwardly, for example about +/−10 mm or +/−5 mm. Depending on the existing mounting space in the base body, also major adjustment tracks are possible.

Basically also several adapter parts are possible, so that one adapter part for example determines the inclination adjustability of the base body and another adapter part for example determines the longitudinal position of the base body for the cycle frame. Equally several adapter parts can be used exclusively for the inclination adjustment or exclusively for the setting of the longitudinal position.

Thus the saddle position can be adjusted in a simple way using different adapter parts, which form a part of the saddle bar.

The base body of the bicycle saddle is particularly preferably a plastic injection moulded part that also can be reinforced.

Other aspects and advantages of the present invention will become apparent from the following.

### BRIEF DESCRIPTION OF THE DRAWINGS

In the following the invention is explained more in detail on the basis of an embodiment as well as a plurality of variants, partially in reference to the included drawing. The drawings show:

FIG. 1 a schematic explosive side view of a bicycle saddle according to the embodiment,

FIG. 2 a side view of the bicycle saddle of FIG. 1,

FIG. 3 a top view on the bicycle saddle of FIG. 1 without saddle bar,

FIG. 4 a top view on the clamping ring, which is the part of the bicycle saddle of FIG. 1, and

FIG. 5 a bottom-up view of the saddle bar, which is a part of the bicycle saddle of FIG. 1.

### DETAILED DESCRIPTION OF EXEMPLARY EMBODIMENTS

In accordance with an exemplary embodiment of the present invention, a bicycle saddle 1 is provided with a seating area 2 and a saddle bar 3. The seating area 2 is contoured for a rider of the bicycle to sit on the seating area 2 with his or her buttocks. The seating area 2 is cushioned by way of cushioning (not shown) on the substantially form-stable base body 4. The base body 4 can be a plastic injection moulded part. The cushioning can be fixed for example by means of velcro fasteners mounted to the base body 4.

Any other fastener is possible, for example a clamping with a rubber band provided on the rim of the cushioning. If necessary, glueing the cushioning would be also conceivable.

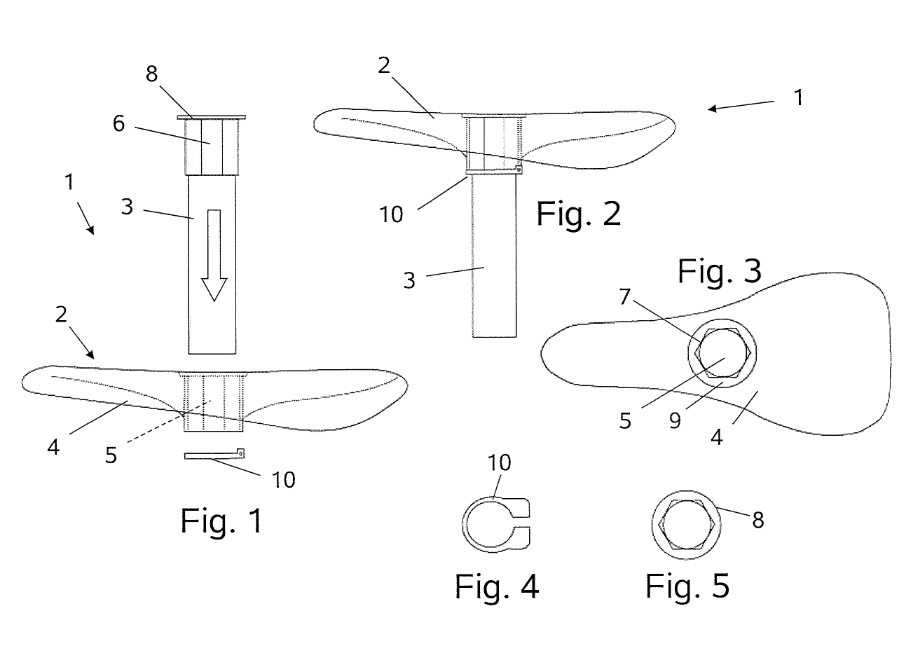

In the base body 4 an upwardly oriented passage opening 5 is provided, through which the saddle bar 3 is introduced from the seat surface of the seating area 2, as indicated by the arrow on the saddle bar 3 in FIG. 1. In order to prevent a twist of the saddle bar 3 relative to the base body 4, the saddle end of the saddle bar 3 is provided with a hexagonal outer profile 6. A corresponding hexagonal inner profile 7 is formed in the base body 4, and the clearance between the profiled areas is small, in order to prevent wobbling of the seating area.

In order to establish a stopper for arresting the introducing of the saddle bar 3 into the passage opening 5, the end of the profiled area of the saddle bar 3 is formed with an outward protruding flange 8. Also in the seat surface of the base body 4 there is a corresponding deepening 9 for admittance of the flange 8. The saddle bar 3 is illustrated in FIG. 5 with a closed lower end, however it is preferably open at the bottom.

The saddle bar 3 is fixed in the base body 4 with the help of a clamping ring 10 pushed from below upwardly along the saddle bar 3, in which a tension screw (not shown) is provided in the clamping ring 10 in order to contract the clamping ring ends.

Any other fixation of the saddle bar 3 in the base body 4 is possible. If necessary, also the saddle bar can be provided with an external thread adjacent the profiled area, on which a nut is screwed. In the base body alternatively threaded inserts can be cast in, into which clamping screws can be screwed, which clamp the saddle bar in the base body.

The upper end of the passage opening 5 in the base body 4 (e.g., an opening defined in the upper end of the saddle bar 3) is closed by means of a rubber plug (not shown) after fitting and fixing the saddle bar 3 by the clamping ring 10, so that the base body 4 together with the rubber plug defines a substantially plane upper surface. Thereafter the cushioning can be applied.

The disassembly of the bicycle saddle 1 is done by removing the cushioning and the rubber plug. Then the clamping ring 10 is loosened and finally the saddle bar 3 is drawn out of the clamping ring 10 and the base body 4.

Though a bicycle saddle with a cushioning is described above, naturally a bicycle saddle can be provided also without cushioning, i. e. the base body, for example formed by a plastic tray accordingly shaped, directly forms the seat. The rubber plug again closes the passage opening for the saddle bar from above.

According to a further variant the saddle bar is multipart with a first part that corresponds substantially to the saddle bar of the practical example and comprises the hollow cylinder profile introduced into the cycle frame at the lower end, and an adapter part, which allows an angular adjustability of the base body as to the hollow cylinder profile to introduce in the cycle frame. The adapter part is completely incorporated in the base body, however it can also protrude below, in order to provide an enlarged contact surface between the first part and the adapter part.

The adapter part externally is provided with a hexagonal outer profile, which assumes the function of the hexagonal outer profile of the saddle bar of the practical example and it is incorporated in the hexagonal inner profile of the base body. Moreover the adapter part is provided with a hexagonal inner profile, which incorporates the end of the first part provided with a corresponding hexagonal outer profile. The two hexagon profiles of the adapter part are not arranged coaxially one towards the other, but here inclined at an angle of 5° one towards the other. This allows a setting of the saddle inclination by 5° forwardly or 5° backwardly, according to the positioning of the adapter part in the base body. Further adapter parts alternatively installable can provide the zero position (coaxial hexagon profile) or other angular adjustability, e.g. 10° forwardly and backwardly or 15° forwardly and backwardly. The angular positions are indicated as the difference to the straight mounting direction of the hollow cylinder profile of the first part.

Stops, here formed by flanges arranged at the end side on the first part and the adapter part, in the assembled state arranged in the area of the seat surface, delimit the introduction depth of the first part into the adapter as well as the adapter introduction depth into the base body. A clamping ring secures the first part as well as the adapter part jammed between the first part and the base body according to the embodiment, but also other fixations are possible.

A corresponding embodiment is also possible with other profiles, e.g. with square profiles. Especially profiles are suitable, which only allow two mounting positions twisted around 180°.

Instead of a different angle of the hexagon profiles, the hexagon profiles of the adapter part, according to a further variant with bipartite saddle bar, can be arranged shifted parallelly one towards the other. Thus the saddle position can be displaced—depending on the alignment of the adapter part—simply forwardly or backwardly, for example about +/−10 mm or with another adapter part about +/−5 mm.

Altogether by means of different base bodies in connection with various saddle bars, first parts and adapter parts, a very flexible and economic module system can be realized, for different saddle forms, saddle inclinations and longitudinal saddle positions relative to the cycle frame.

It will be understood by those skilled in the art that while the present invention has been discussed above with reference to exemplary embodiments, various additions, modifications and changes can be made thereto without departing from the spirit and scope of the invention as set forth in the following claims.

What is claimed is:

1. A bicycle saddle for use with a cycle frame, the bicycle saddle comprising:
a saddle bar for being introduced into the cycle frame; and a seating area comprising a seat surface, wherein an end region of the saddle bar comprises a polygonal outer profile, the seating area being at least partially formed by a base body, a passage opening being provided in the base body, the passage opening comprising at least in a sub-area a polygonal inner profile for receiving the polygonal outer profile of the saddle bar, and the polygonal inner profile of the passage opening corresponds to the polygonal outer profile of the saddle bar.

2. A bicycle saddle according to claim 1, wherein the saddle bar is introduced from the seat surface into the passage opening in the base body.

3. A bicycle saddle according to claim 2, wherein a clamping ring is arranged on the saddle bar, and the clamping ring rests against a side of the base body that is opposite from the seat surface.

4. A bicycle saddle according to claim 2, wherein the base body comprises a contact surface that is oriented toward the seat surface and is positioned above and/or below the polygonal inner profile, against which a corresponding contact surface of the saddle bar rests.

5. A bicycle saddle according to claim 4, wherein the contact surface of the saddle bar is formed by an outward protruding flange arranged at an end of the saddle bar, which is accommodated on the seat surface side of the base body in a deepening at the corresponding contact surface of the base body and rests against the base body.

6. A bicycle saddle according to claim 2, wherein a hole is located at an end of the passage opening, the hole is oriented toward the seat surface, the hole is at least partially defined in the end region of the inserted saddle bar, and the hole is closed by a plug.

7. A bicycle saddle according to claim 2, wherein the polygonal profile is a square profile, hexagon or octagon profile.

8. A bicycle saddle according to claim 2, wherein the saddle bar comprises three sections with different external diameters, in which the first section is formed by a hollow profile or cylinder profile, the second section by said polygonal outer profile with areas protruding at least in the edge regions over the external diameter of the hollow profile or cylinder profile and the third section is formed by a flange protruding at least over the edge region of the polygonal outer profile.

9. A bicycle saddle according to claim 2, wherein the saddle bar is multipart with a first part and an adapter part, the adapter part is arranged between the first part and the base body, and the adapter part comprises at least in one section a polygonal outer profile and a passage opening with a polygonal inner profile provided at least in a sub-area, the base body comprising at least in a sub-area a polygonal inner profile corresponding to the polygonal outer profile of the adapter part, and the first part comprising a polygonal outer profile corresponding to the polygonal inner profile of the adapter part in a section at the end on the seating area side.

10. A bicycle saddle according to claim 9, wherein the polygonal outer profile and the polygonal inner profile of the adapter part each have a cross-section with point symmetry.

11. A bicycle saddle according to claim 9, wherein the polygonal outer profile and the polygonal inner profile of the adapter part are not arranged coaxially one towards the other.

12. A bicycle saddle according to claim 11, wherein the polygonal outer profile and the polygonal inner profile of the adapter part are arranged one towards the other at an angle of more than 0° and less than 15°.

13. A bicycle saddle according to claim 11, wherein the polygonal outer profile and the polygonal inner profile of the adapter part are arranged parallelly displaced one towards the other.

14. A bicycle saddle according to claim 2, wherein the base body is a plastic injection moulded part.
